(19) United States
(12) Patent Application Publication
(10) Pub. No.: US 2014/0095292 A1
(43) Pub. Date: Apr. 3, 2014

(54) COMMUNICATION SYSTEM AND COMMUNICATION METHOD

(71) Applicant: FUJIFILM CORPORATION, Tokyo (JP)

(72) Inventor: Ken MASUDA, Tokyo (JP)

(73) Assignee: FUJIFILM CORPORATION, Tokyo (JP)

(21) Appl. No.: 14/036,014

(22) Filed: Sep. 25, 2013

(30) Foreign Application Priority Data
Sep. 28, 2012 (JP) 2012-217029

(51) Int. Cl. G06Q 30/02

(52) U.S. Cl. CPC G06Q 30/0267
USPC 705/14.41; 705/14.64

(57) ABSTRACT

Each of the calling and the receiving side mobile terminals repeats transmitting its identification information to the base station and receiving notice information from the base station at certain time intervals. When a telephone call is made, the calling side mobile terminal transmits telephone number information to the base station, upon receiving the telephone number information, the base station transmits the identification information of the calling side mobile terminal to the receiving side mobile terminal which corresponds to the received telephone number information, and upon receiving the identification information, the receiving side mobile terminal displays, from among a predetermined number of moving image contents stored in advance, a moving image content corresponding to notice information most recently received from the base station on its display section for a predetermined period of time.

### BACKGROUND OF THE INVENTION

The present invention relates to a communication system and a communication method for performing communications between a mobile terminal of a calling side and a mobile terminal of a receiving side via a base station, and in particular relates to a technique of displaying moving image contents such as advertisements on displays of mobile terminals in such a communication system and communication method.

Nowadays people have been shifting away from newspaper and television, and the concept of mass media advertising is changing. Under circumstances where many people carry and use their mobile terminals such as smartphones, a new approach to advertising in connection with telephone calls through mobile terminals has not yet appeared. On the other hand, silent advertisements seen in train cars are exhibiting a certain effect. With the growing popularity of mobile terminals, there arises a demand for a new advertising approach using mobile terminals.

In relation to the present invention, JP 2003-16348 A, JP 2006-47565 A and JP 2009-514351 A are given as prior art documents.

JP 2003-16348 A describes an advertisement distributing method in which, in response to a call made by a user of a GPS mobile phone to a telephone of a third party, a telephone exchange receives via a wireless base station an outgoing signal added with positional information on the GPS mobile phone, selects an advertising content related to a region which was registered to correspond to the positional information in a radio coverage area, and distributes the selected advertising content to the GPS mobile phone.

JP 2006-47565 A describes an advertisement display method in which when a user presses an email send button, a cellular phone terminal displays advertisement information that was received from an advertisement distributing server at the time of previously sending an email until the email transmission is completed or during a certain period of time, and receives and stores new advertisement information distributed from the advertisement distributing server to be displayed at the next email transmission.

JP 2009-514351 A describes a method that enables a merchant to advertise to customers through a service provider, in which when a customer selects a link on a website, a telephone connection is established between the customer and a registered merchant for free for the customer, and an advertisement for the registered merchant is displayed for the customer in response to the customer's search on a product and/or a service provided by the registered merchant.

### SUMMARY OF THE INVENTION

An object of the present invention is to provide a communication system and communication method capable of distributing moving image contents such as advertisements to be displayed on display sections of mobile terminals in connection with telephone calls.

In order to achieve the above-described object, the present invention provides a communication system for performing communications between a calling side mobile terminal and a receiving side mobile terminal via a base station,

wherein each of the calling side mobile terminal and the receiving side mobile terminal is adapted to repeat transmitting its identification information to the base station and receiving notice information including date and time information and base information from the base station at certain time intervals; and

wherein when a telephone call is made from the calling side mobile terminal to the receiving side mobile terminal,

the calling side mobile terminal is adapted to transmit telephone number information of the receiving side mobile terminal to the base station,

upon receiving the telephone number information from the calling side mobile terminal, the base station is adapted to transmit the identification information of the calling side mobile terminal to the receiving side mobile terminal which corresponds to the received telephone number information, and

upon receiving the identification information of the calling side mobile terminal from the base station, the receiving side mobile terminal is adapted to display, from among a predetermined number of moving image contents stored in advance, a moving image content corresponding to notice information most recently received from the base station on its display section for a predetermined period of time.

Also, the present invention provides a communication method of performing communications between a calling side mobile terminal and a receiving side mobile terminal via a base station, comprising:

a step in which each of the calling side mobile terminal and the receiving side mobile terminal repeats transmitting its identification information to the base station and receiving notice information including date and time information and base information from the base station at certain time intervals,

and further comprising:

when a telephone call is made from the calling side mobile terminal to the receiving side mobile terminal,

a step in which the calling side mobile terminal transmits telephone number information of the receiving side mobile terminal to the base station;

a step in which upon receiving the telephone number information from the calling side mobile terminal, the base station transmits the identification information of the calling side mobile terminal to the receiving side mobile terminal which corresponds to the received telephone number information; and

a step in which upon receiving the identification information of the calling side mobile terminal from the base station, the receiving side mobile terminal displays, from among a predetermined number of moving image contents stored in advance, a moving image content corresponding to notice information most recently received from the base station on its display section for a predetermined period of time.

According to the present invention, moving image contents can be viewed by both users of mobile terminals on calling and receiving sides. Furthermore, since the present invention can draw user's attention at the timing of receiving a telephone call and have the user concentrate on moving image contents, user's view rate becomes high, so that high advertising effectiveness can be expected.

### BRIEF DESCRIPTION OF THE DRAWINGS

FIG. 1 is a schematic diagram illustrating a configuration of a communication system in an embodiment of the invention.

FIG. 2 is a conceptual diagram illustrating an example of an operation of the communication system shown in FIG. 1.

FIG. 3 is a conceptual diagram illustrating an example of an operation of the communication system shown in FIG. 1.

FIG. 4 is a conceptual diagram illustrating an example of an operation of the communication system shown in FIG. 1.

FIG. 5 is a flowchart illustrating an example of an operation of the communication system shown in FIG. 1.

### DETAILED DESCRIPTION OF THE INVENTION

A communication system and a communication method of the invention are described in detail below with reference to a preferred embodiment shown in the accompanying drawings.

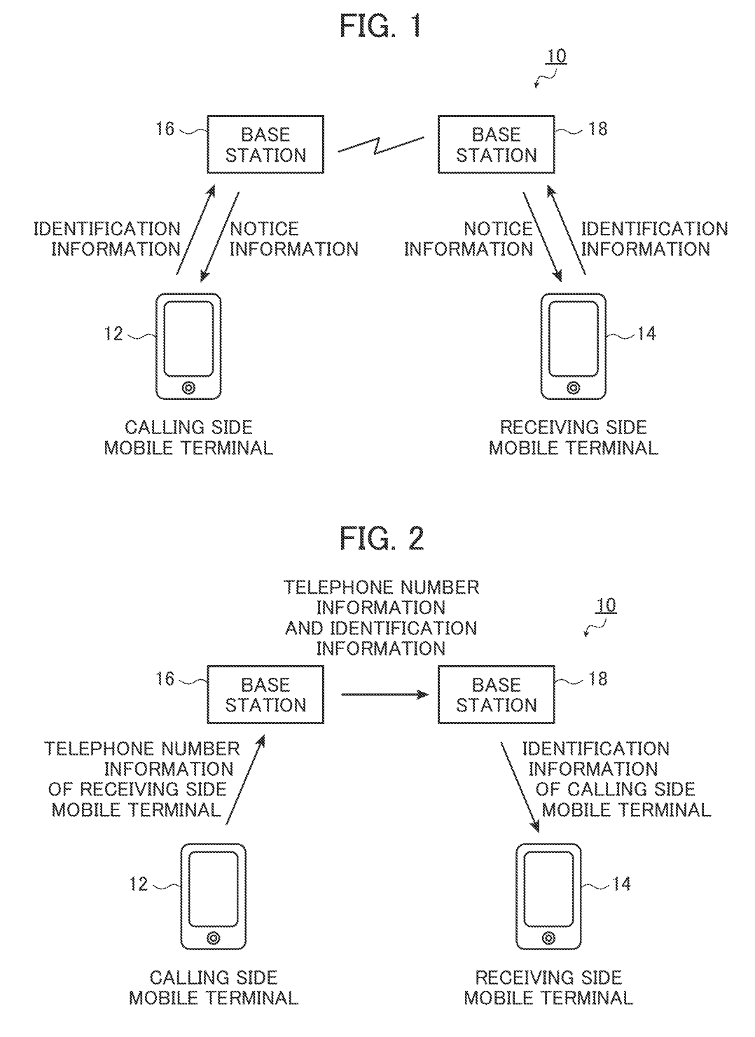

FIG. 1 is a schematic diagram illustrating a configuration of the communication system in the embodiment of the invention. The communication system 10 shown in the figure is provided to perform communications between a mobile terminal of a calling side and a mobile terminal of a receiving side via a base station, and comprises mobile terminals 12 and 14 and base stations 16 and 18.

The mobile terminals 12 and 14 each include a transmitting section and a receiving section for transmitting to and receiving from the base stations 16 and 18 various types of information such as notice information, telephone number information, identification information, receipt information and voice information which will be explained later, a call control section for controlling a microphone, a speaker and telephone calls, a display control section for controlling a display section and moving images on the display section, and a control section for controlling operations of these sections in accordance with a dedicated program to be explained later.

Although the case where a phone call is made from the mobile terminal 12 to the mobile terminal 14 is taken as an example and the explanation is made with the mobile terminal 12 used on a calling side and the mobile terminal 14 used on a receiving side in this embodiment, both the mobile terminals have the same function. Further, in this embodiment, the mobile terminal 12 on the calling side is connected to the base station 16, the base station 16 is connected to the base station 18, and the mobile terminal 14 on the receiving side is connected to the base station 18, so that the calling side mobile terminal 12 is connected to the receiving side mobile terminal 14 via the base stations 16 and 18.

In the case of this embodiment, the calling side and receiving side mobile terminals 12 and 14 are smartphones that each exhibit the function of the communication system 10 as explained below by, for example, installing the dedicated program (application) downloaded from a server such as an application distribution server through a communication function of the mobile terminals, and the program includes a predetermined number of moving image contents prepared in advance. The moving image contents include silent moving images (with no sound) distributed from a server such as an advertisement distribution server, and are mainly contents aimed at advertising, although slide shows and texts for the other purposes may be included in the moving image contents.

While the same program is installed in the calling side and receiving side mobile terminals 12 and 14, this program implements different operations in each of the calling side and receiving side mobile terminals 12 and 14. Specifically, an operation for the calling side is implemented in the calling side mobile terminal while an operation for the receiving side is implemented in the receiving side mobile terminal. Further, this program can be updated during running through the communication function of the mobile terminals 12 and 14. For instance, when an advertiser is changed or a modification to a content of advertisement is desired, or for other reasons, moving image contents are changed as necessary.

It should be noted that the number of base stations is not limited to two, and communications may be performed via one or any number of base stations. Further, one or any number of mobile terminals may be used as the calling side mobile terminal 12 or the receiving side mobile terminal 14.

Each of the calling side and the receiving side mobile terminals 12 and 14 transmits its identification information, e.g., its own telephone number information, to the associated base station 16 or 18, and receives notice information including date and time information and base information from the associated base station 16 or 18. The transmission and reception are repeated at certain time intervals, e.g., every two seconds.

The date and time information is indicative of the date and time at which a communication is performed between a mobile terminal and a base station, and the base information is indicative of which base station is in communication with a mobile terminal.

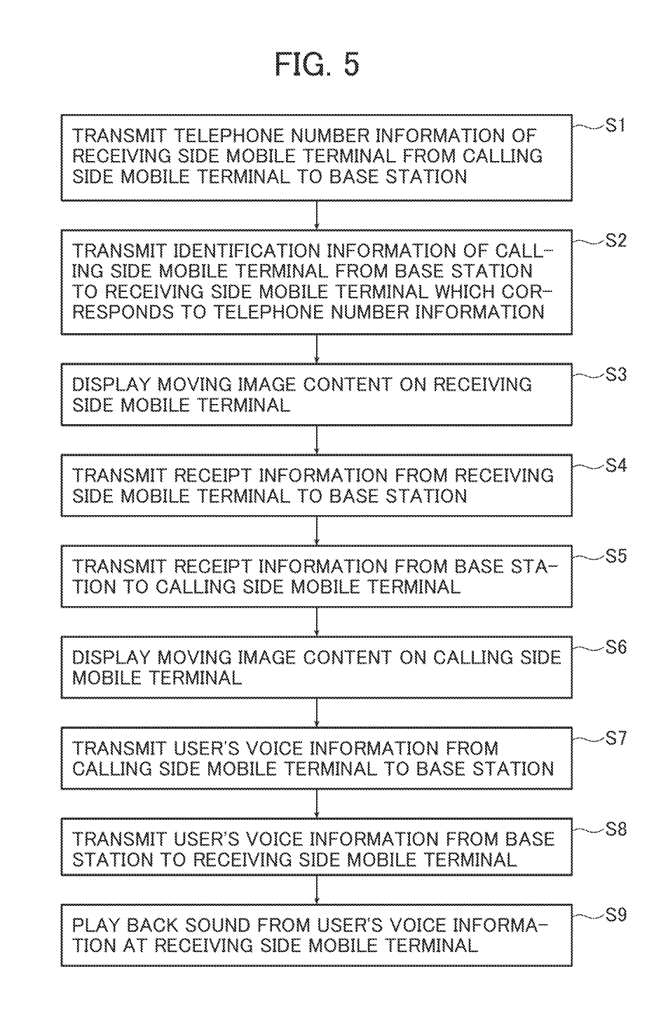

The explanation is made below on the operation of the communication system 10 according to the communication method of this invention with reference to a flowchart of FIG. 5.

In the case where a telephone call is made from the calling side mobile terminal 12 to the receiving side mobile terminal 14, when a user manipulates the calling side mobile terminal 12 to activate a program that serves to achieve the function of the communication system 10 and inputs a telephone number of the receiving side mobile terminal 14, the calling side mobile terminal 12 transmits telephone number information of the receiving side mobile terminal 14 to the base station 16 (step S1 of FIG. 5) as shown in FIG. 2.

Upon receiving the telephone number information from the calling side mobile terminal 12, the base station 16 transmits the received telephone number information and identification information of the calling side mobile terminal 12 to the base station 18 as shown in the figure. Upon receiving the identification information of the calling side mobile terminal 12 and the telephone number information of the receiving side mobile terminal 14, as shown in the figure, the base station 18 transmits the identification information of the calling side mobile terminal 12 to the receiving side mobile terminal 14 that corresponds to the received telephone number information (step S2).

When the receiving side mobile terminal 14 receives from the base station 18 the identification information of the calling side mobile terminal 12 as shown in the figure, i.e., in this embodiment, information on the telephone number of the calling side mobile terminal 12 which differs from the telephone number of the receiving side mobile terminal 14, the program serving to achieve the function of the communication system 10 in the receiving side mobile terminal 14 is automatically activated so that, from among a predetermined number of moving image contents stored in advance, a moving image content corresponding to notice information most recently received from the base station 18 is displayed on a display section of the receiving side mobile terminal 14 for a predetermined period of time, e.g., 10 to 15 seconds (step S3).

The receiving side mobile terminal 14 displays the moving image content regardless of whether or not a user answers the telephone, i.e., presses a call button.

In the case of using a normal communication system for telephone calls, when a telephone call is made from a calling side mobile terminal to a receiving side mobile terminal, a phone ring (ring tone) of the receiving side mobile terminal goes off and, in response thereto, a user presses a call button to enable the call.

On the other hand, in the case of using the communication system 10 of this embodiment, when the receiving side mobile terminal 14 receives the identification information of the calling side mobile terminal 12 from the base station 18, the program serving to achieve the function of the communication system 10 in the receiving side mobile terminal 14 is activated with no phone ring, and the activated program makes the receiving side mobile terminal 14 display a moving image content on its display.

In the receiving side mobile terminal 14, setting of no phone ring is not indispensable and a phone ring may be set to ring.

The time to start displaying a moving image content and a region associated with the moving image content are determined for each moving image content in advance by an advertiser. A moving image content starts to be displayed in accordance with date and time information and base information included in notice information that a receiving side mobile terminal has received from a base station. Specifically, this moving image content is defined to be displayed from the time point in the date and time information in a region of the base station of the base information. Accordingly, if a phone ring is set to ring, the time to start displaying a moving image content is delayed by the ringing period and hence, setting of no phone ring is preferred.

The time to be taken to answer the telephone after a phone ring starts depends on each person. Assuming the time to be five seconds, in the case of using a normal communication system for telephone calls, a name of the caller and the telephone number thereof are to be displayed on a display section of a receiving side mobile terminal during this period of time. If, however, the user sees the screen of the display section of the mobile terminal for this five seconds, it is preferred to use the five seconds to display a moving image content.

An alarm program that produces an alarm sound in accordance with notice information received from a base station may be exemplified as a program installed in a mobile terminal and automatically activated to be operated. However, such an alarm program is activated in response to notice information from a base station, while the program serving to achieve the function of the communication system 10 of this embodiment is automatically activated in response to receipt of a telephone call from another mobile terminal. Thus those programs are different.

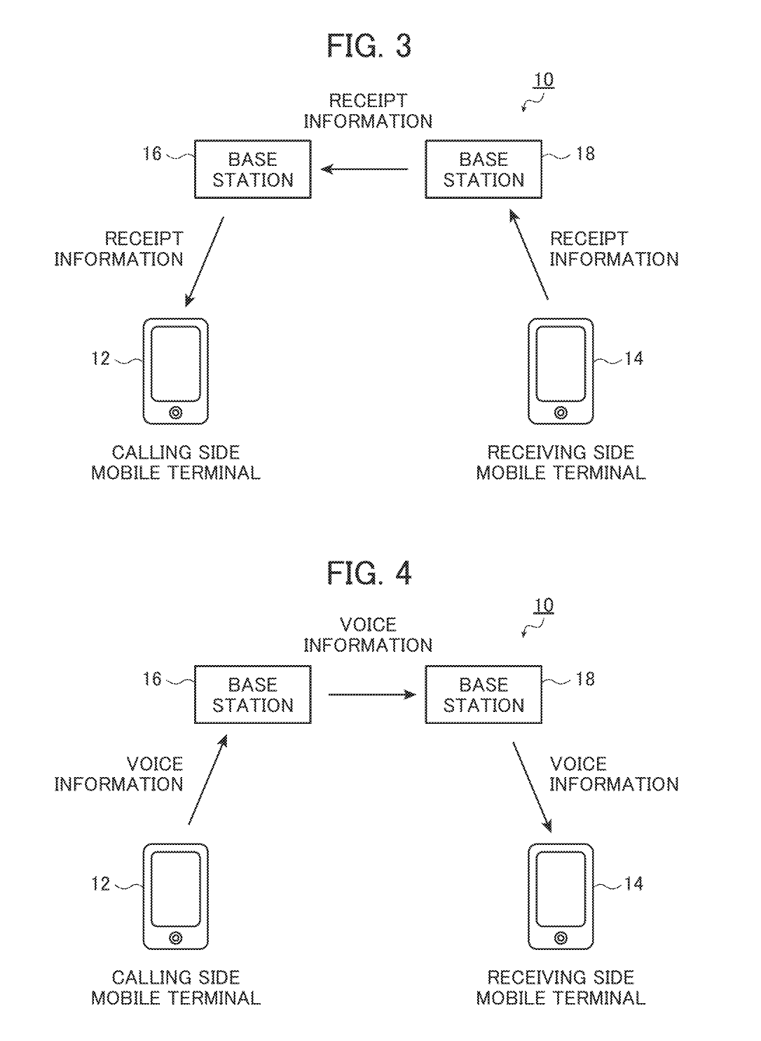

Subsequently, upon receiving the identification information of the calling side mobile terminal 12 from the base station 18, the receiving side mobile terminal 14 transmits to the base station 18 receipt information indicative of receipt of the telephone call from the calling side mobile terminal 12 (step S4) as shown in FIG. 3.

Upon receiving the receipt information from the receiving side mobile terminal 14, as shown in the figure, the base station 18 transmits the received receipt information to the base station 16, and the base station 16 transmits the receipt information received from the base station 18 to the calling side mobile terminal 12 that has transmitted the telephone number information of the receiving side mobile terminal 14 which corresponds to the received receipt information (step S5) as shown in the figure.

Upon receiving the receipt information from the base station 16 as shown in the figure, the calling side mobile terminal 12 displays, from among a predetermined number of moving image contents stored in advance, a moving image content corresponding to notice information most recently received from the base station 16 on its display section for a predetermined period of time, e.g., 10 to 15 seconds in the same manner (step S6).

A moving image content to be displayed on the display section of the calling side or receiving side mobile terminal 12 or 14 is selected from among a predetermined number of moving image contents included in the program serving to achieve the function of the communication system 10 based on notice information most recently received from the associated base station 16 or 18 to which the calling side or receiving side mobile terminal 12 or 14 sends its identification information. Accordingly, moving image contents displayed on the calling side and receiving side mobile terminals 12 and 14 are not necessarily the same.

A moving image content to be displayed is determined in accordance with the notice information in such a manner that, for example, in a mobile terminal connected to a certain base station, a corresponding moving image content is displayed from a certain time point until another certain time point. As described above, the calling side and receiving side mobile terminals 12 and 14 acquire notice information from the associated base station 16 and 18 at predetermined time intervals. Consequently, in each of the calling side and receiving side mobile terminals 12 and 14, a moving image content corresponding to notice information most recently received from the associated base station 16 or 18 is displayed on the display section.

Furthermore, the calling side mobile terminal 12 can send voice information of the user to the base station 16 for free during the predetermined period of time in which a moving image content is displayed on its display section (step S7) as shown in FIG. 4. In other words, the user of the calling side mobile terminal 12 can speak on the telephone for free during the predetermined period of time in which a moving image content is displayed.

As shown in the figure, upon receiving the voice information of the user from the calling side mobile terminal 12, the base station 16 transmits the received voice information to the base station 18 and, as shown in the figure, the base station 18 transmits the voice information received from the base station 16 to the receiving side mobile terminal 14 as well (step S8).

The receiving side mobile terminal 14 receives the voice information of the user of the calling side mobile terminal 12 from the base station 18 and plays back sounds from the voice information during the predetermined period of time in which a moving image content is displayed on its display section (step S9).

In this embodiment, the receiving side mobile terminal 14 is configured to be unable to send voice information of the user of the receiving side mobile terminal 14 to the calling side mobile terminal 12 during the predetermined period of time in which a moving image content is displayed on its display section. This configuration can make the user of the receiving side mobile terminal 14 concentrate on a voice of the user of the calling side mobile terminal 12 and the moving image content displayed on the display section.

It should be noted that this configuration is not indispensable and voice information of the user of the receiving side mobile terminal 14 may be transmitted from the receiving side mobile terminal 14 to the calling side mobile terminal 12 during displaying a moving image content.

Alternatively, instead of the configuration in which the user of the calling side mobile terminal 12 can speak on the telephone for free during the predetermined period of time in which a moving image content is displayed, an amount of money corresponding to a call charge for the predetermined period of time may be deducted from the basic charge.

The communication system 10 charges an advertiser that is a supplier of a displayed moving image content for an advertisement charge (cost) based on the number of times of received calls, i.e., the number of times the moving image content has been displayed in the calling side or receiving side mobile terminal 12 or 14. This can be carried out through an existing on-line billing system. The users of the calling side and receiving side mobile terminals 12 and 14 may view any moving image content included in the program any time as desired, and in this case, the advertiser of the viewed moving image content is not charged for the advertisement.

In the communication system 10 of this embodiment, moving image contents can be viewed by both users of the calling side and receiving side mobile terminals 12 and 14 in response to receipt of a telephone call. For example, while silent advertisements on paper media such as magazines, newspapers and posters do not have a function to draw user's attention, the communication system 10 can draw user's attention at the timing of receiving a telephone call and make the user concentrate on moving image contents. As a result, user's view rate becomes high, so that high advertising effectiveness can be expected.

In order to make a user see a moving image content displayed on a display section of a mobile terminal, it is necessary to play back a voice of a caller at a high volume so that the user can adequately hear the voice without holding the mobile terminal on his/her ear during displaying the moving image content.

When a mobile terminal is of having a display panel as a display section like a smartphone, a certain type of such a mobile terminal emits panel sounds from its display panel in addition to speaker sounds emitted from its speaker. In general, a panel sound is lower in volume than a speaker sound and even when a volume of panel sound is adjusted to the maximum, a voice of the caller tends to be hard to hear unless the user holds the mobile terminal on his/her ear. On the other hand, a speaker sound is sufficiently high in volume even when the user does not hold the mobile terminal on his/her ear.

Therefore, when a moving image content is displayed, it is preferred that the program installed in the mobile terminal switch a sound to the speaker sound and, if necessary, automatically adjust a volume of the speaker sound.

In addition, in the case where a cover is put on a body of a mobile terminal for breakage prevention, water resistant purpose or the like, since a voice of the caller needs to be played back at a sufficient volume, it is important not to cover a portion corresponding to a speaker. Unless the cover has a hole at a position corresponding to the speaker, a sound emitted from the speaker is absorbed into the cover and it results in a difference in volume between a sound having been adjusted and a sound the user actually hears. Therefore, a portion corresponding to the speaker is preferably not covered by the cover.

A material of the cover is preferably low in sound absorbing property. A shape of the cover preferably functions to amplify a sound emitted from the speaker, for example, a shape that enables the user to hear a sound through earphones.

The communication system 10 preferably functions also for a call from a blocked telephone number and a collect call.

Next, a method of displaying (playing back) a moving image content will be explained.

Possible methods of displaying a moving image content or contents include patterns (1) to (8) as follows, for instance.
(1) A full-screen image of a single company
(2) Full-screen images of a plurality of companies to be displayed sequentially (in a row(s) at the end); and a quiz
(3) Arranged plural images of a plurality of companies
(4) Arranged plural images of a plurality of companies; and a quiz
(5) Arranged plural images of a plurality of companies to be displayed with a time lag (in which displaying events are partially overlapped in the timeline)
(6) Arranged plural images of a plurality of companies to be displayed with a time lag; and a quiz
(7) Arranged plural images of a single company to be displayed with a time lag
(8) Arranged plural images of a single company to be displayed with a time lag; and a quiz

In the displaying method (1), a moving image content of a single company is solely displayed over the full screen of a display section of a mobile terminal for a predetermined period of time.

In the displaying method (2), moving image contents of a plurality of companies are sequentially displayed over the full screen of a display section of a mobile terminal by switching the displayed moving image content at certain intervals that are defined by dividing a predetermined period of time. For instance, when the predetermined period of time is 15 seconds and moving image contents of three companies are displayed, a moving image content of one of the companies is displayed over the full screen of the display section of the mobile terminal for five seconds and sequentially switched to different moving image content of another company after five seconds.

An ending arrangement follows in which the screen of the display section of the mobile terminal is divided so that all the moving image contents of the plurality of companies are simultaneously displayed after those moving image contents are all sequentially displayed.

A quiz concerning the displayed moving image contents is given after the ending arrangement to increase interest of the user who sees the moving image contents. A quiz may ask a question that, for example, “to which company the moving image content appeared second is related.”

In the displaying method (3), a screen of a display section of a mobile terminal is divided so that moving image contents of a plurality of companies are simultaneously displayed for a predetermined period of time. For instance, when moving image contents of four companies are displayed, the display section of the mobile terminal is divided into four sections so that the moving image contents of the four companies are simultaneously displayed on the display section of the mobile terminal.

In the displaying method (4), a screen of a display section of a mobile terminal is divided so that moving image contents of a plurality of companies are simultaneously displayed for a predetermined period of time as in the displaying method (3), whereafter a quiz follows.

In the displaying method (5), a screen of a display section of a mobile terminal is divided so that moving image contents of a plurality of companies are played back at one time for a predetermined period of time with a time lag. For example, a moving image content of the first company is played back on the left side of the screen and before the playing back of the moving image content of the first company finishes, another moving image content of the second company is started to play back on the right side of the screen with a time lag, in other words, with a delay of a predefined period of time. The user can see either one of the two moving image contents as desired.

In the displaying method (6), a screen of a display section of a mobile terminal is divided so that moving image contents of a plurality of companies are each played back for a predetermined period of time with a time lag as in the displaying method (5), whereafter a quiz follows.

In the displaying method (7), a screen of a display section of a mobile terminal is divided so that moving image contents of a single company are each played back for a predetermined period of time with a time lag. The moving image contents may be the same or different.

In the displaying method (8), a screen of a display section of a mobile terminal is divided so that moving image contents of a single company are played back with a time lag as in the displaying method (7), whereafter a quiz follows.

It should be noted that the above-described moving image content is not limited to the one provided by a company for advertising purposes. A method for displaying a moving image content or contents is not limited to the above-described methods. For instance, a variety of displaying methods may be employed by appropriately combining the above-described methods.

It is desired for the calling side and receiving side mobile terminals 12 and 14 to each display buttons such as “Love” and “Annoying” in the displayed moving image content so as to allow the user to input the user's evaluation on the moving image content displayed on the display section. This configuration enables to obtain users' evaluations on moving image contents as inputted by the users through the buttons.

When a user presses the “Love” button, an email having a coupon is distributed to the mobile terminal of the user, for instance. As a result, upon viewing the moving image content, the user can have a benefit of receiving the coupon.

On the other hand, when a user presses the “Annoying” button, for instance, the relevant moving image content is deleted from the program installed in the user's mobile terminal, and a display termination notice directed to the relevant moving image content is sent to the advertiser based on points corresponding to the number of times the “Annoying” button was pressed. As a result, the advertiser can avoid giving negative impression to the user by the moving image content and also consider the time to delete the moving image content.

This invention is basically as described above.

While the present invention has been described above in detail, the invention is not limited to the above embodiment, and various improvements and modifications may be made without departing from the spirit and scope of the invention.

What is claimed is:

1. A communication system for performing communications between a calling side mobile terminal and a receiving side mobile terminal via a base station,
wherein each of the calling side mobile terminal and the receiving side mobile terminal is adapted to repeat transmitting its identification information to the base station and receiving notice information including date and time information and base information from the base station at certain time intervals; and
wherein when a telephone call is made from the calling side mobile terminal to the receiving side mobile terminal,
the calling side mobile terminal is adapted to transmit telephone number information of the receiving side mobile terminal to the base station,
upon receiving the telephone number information from the calling side mobile terminal, the base station is adapted to transmit the identification information of the calling side mobile terminal to the receiving side mobile terminal which corresponds to the received telephone number information, and
upon receiving the identification information of the calling side mobile terminal from the base station, the receiving side mobile terminal is adapted to display, from among a predetermined number of moving image contents stored in advance, a moving image content corresponding to notice information most recently received from the base station on its display section for a predetermined period of time.

2. The communication system according to claim 1,
wherein upon receiving the identification information of the calling side mobile terminal from the base station, the receiving side mobile terminal is adapted to transmit to the base station receipt information indicative of receipt of a telephone call from the calling side mobile terminal;
upon receiving the receipt information from the receiving side mobile terminal, the base station is adapted to transmit the received receipt information to the calling side mobile terminal that has transmitted the telephone number information of the receiving side mobile terminal which corresponds to the received receipt information; and
upon receiving the receipt information from the base station, the calling side mobile terminal is adapted to display, from among a predetermined number of moving image contents stored in advance, a moving image content corresponding to notice information most recently received from the base station on its display section for a predetermined period of time.

3. The communication system according to claim 2,
wherein the calling side mobile terminal is adapted to transmit voice information of a user to the base station during the predetermined period of time in which the moving image content is displayed on its display section;
upon receiving the voice information of the user from the calling side mobile terminal, the base station is adapted to transmit the received voice information to the receiving side mobile terminal; and
the receiving side mobile terminal is adapted to receive the voice information of the user of the calling side mobile terminal from the base station and to play back a sound from the voice information during the predetermined period of time in which the moving image content is displayed on its display section.

4. The communication system according to claim 3,
wherein the receiving side mobile terminal is adapted not to transmit voice information of a user of the receiving side mobile terminal from the receiving side mobile terminal to the calling side mobile terminal during the predetermined period of time in which the moving image content is displayed on its display section.

5. The communication system according to claim 1,
wherein each of the calling side mobile terminal and the receiving side mobile terminal is a smartphone which is installed with a program including the predetermined number of moving image contents, thereby achieving a function of the communication system.

6. The communication system according to claim 5,
wherein the program and the moving image contents are adapted to be updated through a communication function provided in each of the calling side mobile terminal and the receiving side mobile terminal during running of the program.

7. The communication system according to claim 5,
wherein the program in the receiving side mobile terminal is adapted to be activated in response to receipt of the identification information of the calling side mobile terminal from the base station to cause the moving image content to be displayed on the display section of the receiving side mobile terminal for a predetermined period of time.

8. The communication system according to claim 5,
wherein when the moving image content is displayed on the display section, the program is adapted to switch a sound to a speaker sound emitted from a speaker provided in each of the calling side mobile terminal and the receiving side mobile terminal and to adjust a volume of the speaker sound.

9. The communication system according to claim 1,
wherein the receiving side mobile terminal is adapted not to allow a phone ring to ring when receiving the identification information of the calling side mobile terminal from the base station.

10. The communication system according to claim 1,
wherein each of the calling side mobile terminal and the receiving side mobile terminal is adapted to display solely one moving image content over a full screen of its display section for the predetermined period of time.

11. The communication system according to claim 1,
wherein each of the calling side mobile terminal and the receiving side mobile terminal is adapted to sequentially display a plurality of moving image contents over a full screen of its display section by switching a displayed moving image content among the plurality of moving image contents at certain intervals that are defined by dividing the predetermined period of time, and then to simultaneously display all the plurality of moving image contents on the screen by dividing the screen.

12. The communication system according to claim 1,
wherein each of the calling side mobile terminal and the receiving side mobile terminal is adapted to simultaneously display a plurality of moving image contents on a screen of its display section by dividing the screen for the predetermined period of time.

13. The communication system according to claim 1,
wherein each of the calling side mobile terminal and the receiving side mobile terminal is adapted to play back a plurality of moving image contents at one time on a screen of its display section by dividing the screen for the predetermined period of time with a time lag.

14. The communication system according to claim 1,
wherein each of the calling side mobile terminal and the receiving side mobile terminal is adapted to play back one moving image content on each portion of divided screen of its display section for the predetermined period of time with a time lag.

15. The communication system according to claim 10,
wherein each of the calling side mobile terminal and the receiving side mobile terminal is adapted to give a quiz concerning the displayed moving image content after displaying the moving image content.

16. The communication system according to claim 1,
wherein each of the calling side mobile terminal and the receiving side mobile terminal is adapted to display a button in the moving image content to allow a user to input the user's evaluation on the moving image content displayed on the display section, thereby obtaining the user's evaluation on the moving image content inputted by the user by pressing the button.

17. The communication system according to claim 1,
wherein the communication system is adapted to charge a cost to a supplier of the moving image content based on a number of times the moving image content is displayed in the calling side mobile terminal and the receiving side mobile terminal.

18. A communication method of performing communications between a calling side mobile terminal and a receiving side mobile terminal via a base station, comprising:
a step in which each of the calling side mobile terminal and the receiving side mobile terminal repeats transmitting its identification information to the base station and receiving notice information including date and time information and base information from the base station at certain time intervals,
and further comprising:
when a telephone call is made from the calling side mobile terminal to the receiving side mobile terminal,
a step in which the calling side mobile terminal transmits telephone number information of the receiving side mobile terminal to the base station;
a step in which upon receiving the telephone number information from the calling side mobile terminal, the base station transmits the identification information of the calling side mobile terminal to the receiving side mobile terminal which corresponds to the received telephone number information; and
a step in which upon receiving the identification information of the calling side mobile terminal from the base station, the receiving side mobile terminal displays, from among a predetermined number of moving image contents stored in advance, a moving image content corresponding to notice information most recently received from the base station on its display section for a predetermined period of time.

19. The communication method according to claim 18, further comprising:
a step in which upon receiving the identification information of the calling side mobile terminal from the base station, the receiving side mobile terminal transmits to the base station receipt information indicative of receipt of a telephone call from the calling side mobile terminal;
a step in which upon receiving the receipt information from the receiving side mobile terminal, the base station transmits the received receipt information to the calling side mobile terminal that has transmitted the telephone number information of the receiving side mobile terminal which corresponds to the received receipt information; and
a step in which upon receiving the receipt information from the base station, the calling side mobile terminal displays, from among a predetermined number of moving image contents stored in advance, a moving image content corresponding to notice information most recently received from the base station on its display section for a predetermined period of time.

20. The communication method according to claim 19, further comprising:
a step in which the calling side mobile terminal transmits voice information of a user to the base station during the predetermined period of time in which the moving image content is displayed on its display section;
a step in which upon receiving the voice information of the user from the calling side mobile terminal, the base station transmits the received voice information to the receiving side mobile terminal; and
a step in which the receiving side mobile terminal receives the voice information of the user of the calling side mobile terminal from the base station and plays back a sound from the voice information during the predetermined period of time in which the moving image content is displayed on its display section.
